(19) United States
(12) Patent Application Publication
(10) Pub. No.: US 2007/0160517 A1
(43) Pub. Date: Jul. 12, 2007

(54) Catalyst, a method of using a catalyst, and an arrangement including a catalyst, for controlling NO and/or CO emissions from a combustion system without using external reagent

(75) Inventors: Zhen Fan, Parsippany, NJ (US); Song Wu, Livingston, NJ (US); Richard G. Herman, Whitehall, PA (US)

Correspondence Address: FITZPATRICK CELLA HARPER & SCINTO, 30 ROCKEFELLER PLAZA, NEW YORK, NY, 10112, US

(73) Assignee: FOSTER WHEELER ENERGY CORPORATION, Clinton, NJ (US)

(21) Appl. No.: 11/515,748

(22) Filed: Sep. 6, 2006

Related U.S. Application Data
(63) Continuation-in-part of application No. 11/313,805, filed on Dec. 22, 2005.

(51) Int. Cl. B01D 53/64; B01D 53/46; B01D 47/00; B01D 53/94

(52) U.S. Cl. 423/210; 423/213.2

(57) ABSTRACT

A catalyst, a method of and an arrangement for using a catalyst for controlling NO and/or CO emissions from a combustion system that combusts carbonaceous fuels, including introducing carbonaceous fuel and combustion air into a furnace of the combustion system for combusting the carbonaceous fuel in oxidizing conditions and producing flue gas that includes NO and/or CO, wherein the ratio of molar concentrations of CO and NOₓ is preferably at least 0.7, and leading flue gas from the furnace to contact with a catalyst in a flue gas channel, wherein the catalyst has a metal oxide loading comprising oxides of iron and one or more of a group consisting of copper, cerium and potassium, deposited on a porous support material, wherein the metal oxide loading is preferably 1-20% of the weight of the support material and ratio of the weight of oxides the group consisting of copper, cerium and potassium to the weight of iron oxides is preferably from 0.25 to 3, for converting, free from introducing an external agent for NO reduction, NO to N₂, by using CO as the reductant of NO, and/or CO to CO₂.

This application is a continuation-in-part of copending Application Ser. No. 11/313,805, filed on Dec. 22, 2005.

### BACKGROUND OF THE INVENTION

1. Field of the Invention

The present invention relates to a catalyst, a method of using a catalyst, and an arrangement including a catalyst, for controlling the NO and/or CO levels in flue gases emitted from a combustion system combusting carbonaceous fuels. More particularly, the present invention relates to an NO and/or CO control scheme that is free from injecting an external NOₓ reducing agent.

2. Description of the Related Art

NOₓ emissions from carbonaceous fuel-firing boilers originate from two sources: (1) thermal NOₓ due to oxidation of nitrogen in the air and (2) fuel NOₓ due to oxidation of nitrogen in the fuel. In today's boilers, with advanced combustion systems, thermal NOₓ is minimal, and NOₓ emissions are mainly formed from a small fraction of nitrogen in the fuel. The level of NOₓ produced in a combustion process is mainly determined by the temperature and stoichiometry of the primary combustion zone. The level of NOₓ emissions exiting from a combustor to the atmosphere results as an equilibrium between the NOₓ formation reactions and NOₓ reduction reactions.

Existing technologies for controlling NOₓ emissions from combustion sources fall within two categories: (1) minimizing the NOₓ formation in the combustion process and (2) reducing the NOₓ level in the produced flue gas. In pulverized coal (PC) boilers, the NOₓ formation can be minimized by using specially designed low NOₓ burners (LNB) and by completing the coal combustion at the upper level of the furnace by over-fire-air (OFA). In fluidized bed combustion (FBC), the NOₓ levels are usually controlled by using a relatively low combustion temperature and by adjusting secondary air for optimized air staging. The main flue gas NOₓ reduction technologies include selective catalytic reduction (SCR) and selective non-catalytic reduction (SNCR), which both usually utilize ammonia or urea to destroy NOₓ, once it has formed.

Today, the levels of NOₓ emission required of new coal-fired utility boilers are often in the range of 40-60 ppm. These low levels of NOₓ emissions are achieved by optimized integration of both categories of NOₓ control technologies. For example, a common arrangement for PC boilers is an LNB/OFA system in combination with an SCR using ammonia or urea as the reductant. When using an LNB/OFA system, the NOₓ level at the exit of the furnace is typically in the range of 90-180 ppm.

The current low NOₓ technologies used in carbonaceous fuel-combusting boilers emphasize the precise control of combustion stoichiometry and temperature within the primary combustion zone. It is well known that a low level of excess air in the combustion zone may lead to increased CO emissions and unburned carbon in the ash. Thus, the current low NOₓ combustion technologies (LNB and FBC) are, due to CO emission concerns, unable to take full advantage of optimizing the amount of excess air. The currently used design strategy has thus been focused on reducing the available oxygen in the primary combustion zone to a low level to minimize NOₓ formation while at the same time maintaining high combustion efficiency and a low level of CO emissions.

A problem with the SCR and SNCR reduction systems, however, is that the use of excessive amounts of ammonia or urea to achieve very high NOₓ reduction levels leads to harmful ammonia emissions to the environment. Ammonia handling and injection systems create significant capital and operational costs. The use of ammonia also causes safety risks to the operating personnel, and may result in ammonia salt formation, and fouling and corrosion on cold downstream surfaces of the flue gas channel.

In the automotive industry, it is known to use the so-called Three-way Converters (TWC) to simultaneously reduce NOₓ, CO and hydrocarbon (HC) emissions in the exhaust gas. The conventional gasoline engine runs at stoichiometric conditions, controlled by fuel injection. A TWC contains a catalyst, which is usually made of either platinum or palladium together with rhodium on a ceramic or metal substrate. Such catalysts function efficiently in engine exhaust oscillating just rich of the stoichiometric air-to-fuels (A/F) ratio in a narrow A/F window, so that conversion of NOₓ, CO and HC's occurs. CO functions as the NOₓ reductant over the rhodium surface, and the excess CO and hydrocarbons are oxidized over the platinum or palladium surfaces.

U.S. Pat. No. 5,055,278 discloses a method of decreasing the amount of nitrogen oxides in waste furnace gas. According to the method, fossilized fuel is passed through gradual pyrolizing combustion for prolonged residence time, and the formed carbon monoxide, hydrocarbons, and possible nitrogen oxides, are passed through catalytic oxidation in a noble metal catalyst. Due to the substoichiometric conditions, very high amounts of CO and hydrocarbons are produced, and a large amount of catalyst is required for the oxidation.

U.S. Pat. No. 6,979,430 (CHECK, OR application No. 2004-0120872) discloses a method of controlling NOₓ emissions from a boiler that combusts carbonaceous fuels in oxidizing conditions and producing flue gas that includes NOₓ and CO. The disclosed method comprises leading flue gas from the furnace to a catalyst section in a flue gas channel for converting, free from introducing an external agent for NOₓ reduction, NOₓ to N₂ and CO to CO₂ by using CO as the reductant of NOₓ on a catalyst in the catalyst section. The method further comprises adjusting the operating conditions in the furnace so as to decrease the molar concentration of NOₓ and to increase the molar concentration of CO at the furnace exit so that the ratio of the molar concentrations of CO and NOₓ at the furnace exit is above 0.7.

The U.S. Pat. No. 6,979,430 (CHECK, OR application No. 2004-0120872) discloses a new process for simple system level integration between the combustion process of a boiler and the downstream flue gas NOₓ reduction, which maintains high thermal efficiency and leads to very low NOₓ emissions, but does not cause harmful ammonia or CO emissions. However, there still exists a need for an efficient catalyst to be used in the disclosed process, and an efficient method and arrangement for using the catalyst in the process.

### SUMMARY OF THE INVENTION

An object of the present invention is to provide an efficient catalyst for a process of controlling NO and/or CO emissions from boilers combusting carbonaceous fuels without using an external agent, and a method and arrangement for using such a catalyst.

According to an aspect of the present invention, a catalyst for controlling emissions of NO and/or CO from a combustion process that combusts carbonaceous fuels in oxidizing conditions is provided, wherein the catalyst has a metal oxide loading comprising oxides of iron and one or more of a group consisting of copper, cerium and potassium, deposited on a porous support material for converting, free from introducing an external agent for NO reduction, NO to N₂, by using CO as the reductant of NO, and/or CO to CO₂.

According to another aspect of the present invention, a method of controlling NO and/or CO emissions from a combustion system that combusts carbonaceous fuels is provided, wherein the method comprises the steps of: (a) introducing carbonaceous fuel and combustion air into a furnace of the combustion system for combusting the carbonaceous fuel in oxidizing conditions and producing flue gas that includes NO and/or CO; and (b) leading flue gas from the furnace to contact with a catalyst in a flue gas channel, wherein the catalyst has a metal oxide loading comprising oxides of iron and one or more of a group consisting of copper, cerium and potassium, deposited on a porous support material for converting, free from introducing an external agent for NO reduction, NO to N₂, by using CO as the reductant of NO, and/or CO to CO₂.

Also, according to a third aspect of the present invention, an arrangement for controlling NO and/or CO emissions from a combustion system that combusts carbonaceous fuels is provided, the arrangement comprising a furnace including means for introducing carbonaceous fuel and combustion air into the furnace for combusting the carbonaceous fuel in oxidizing conditions and producing flue gas including NO and/or CO; a flue gas channel for leading the flue gas from the furnace to the atmosphere; and a catalyst section in the flue gas channel including a catalyst having a metal oxide loading comprising oxides of iron and and one or more of a group consisting of copper, cerium and potassium, deposited on a porous support material for converting, free from introducing an external agent for NO reduction, NO to N₂, by using CO as the reductant of NO, and/or CO to CO₂.

According to a preferred embodiment of the present method, the level of CO generated in a combustion process in the furnace is adjusted to a level at which it reduces NOₓ to nitrogen (N₂) both in the furnace and in the downstream catalytic section, without using any external reagents, such as ammonia. The processes in the furnace are preferably adjusted so that the ratio of the molar concentrations of CO and NOₓ in the flue gas entering the catalyst section is at least about 0.7. Even more preferably, the molar concentration of CO in the flue gas entering the catalyst section is from about 1 to about 3 times the molar concentration of NOₓ. As is well-known to persons skilled in the art, a desired concentration of CO can be generated through optimization of the furnace design and operation parameters, for example, the ratio of the fuel and air introduced into the furnace.

The operation conditions in the furnace, adjusted to bring about relatively high CO production, also significantly suppress the NOₓ generation in the combustion process. In addition to that, when NOₓ, CO and char are produced in the furnace, the CO acts together with the char in reducing the NOₓ level further, according to the following reaction:

2NO+2CO→N₂+2CO₂ (over char surface, high temperature). (1)

The furnace will advantageously be operated with high CO concentrations to achieve furnace exit NOₓ levels, which, due to the decreased NOₓ production and the NOₓ reduction in the furnace, are significantly lower than those obtained by using the current low NOₓ combustion technologies. Advantageously, the NOₓ level at the furnace exit may be below 90 ppm, even below 60 ppm.

The NO and/or CO levels in the flue gas, having a rich CO/NOₓ ratio, are, according to the present invention, further reduced in a catalyst section arranged in the flue gas channel. However, due to the low original NOₓ level in the flue gas, the need for catalytic NOₓ reduction is relatively low.

According to the present invention, NOₓ reduction on the catalyst can take place without adding any external reagent to the process. In present commercial power plants, ammonia and urea are generally used for performing catalytic or non-catalytic NOₓ reduction. However, as is known to persons skilled in the art, other reductants, such as CO, hydrocarbons (HC), hydrogen and char, can also be used to reduce NOₓ to nitrogen. The reductant is oxidized in the same reaction, as is shown below for the reaction between NOₓ and CO:

2NO+2CO→N₂+2CO₂ (over metal catalyst, low temperature) (2)

This is the same reaction as reaction (1), but with an external metal catalyst. Reaction (2) is proven and widely used at stoichiometric conditions in the automotive industry, wherein high NOₓ conversion levels, usually between 90 and 99%, are achievable.

The boiler flue gas contains also hydrocarbons (HC), usually in a concentration of a lower order of magnitude than CO. As mentioned above, HC may also reduce NOₓ through redox reactions similar to the NOₓ—CO reactions shown in formula (2). Measures taken to increase the amount of CO in the furnace will also, to some degree, increase the HC concentration. However, due to its low concentration and similar reaction mechanism, the effect of HC on NOₓ is, in this description of the present invention, combined into the CO reduction effect. Also, in engineering calculations, the CO/NOₓ molar ratio may include the contribution of the equivalent of a CH₄/NOₓ ratio.

According to a preferred embodiment of the present invention, the catalyst comprises as active catalyst materials oxides of iron and copper, which are deposited on a porous support material. The oxides may advantageously be Fe₂O₃ and CuO, but they may be also in other mono-, bi- or ternary oxide forms. In some applications, the catalyst may advantageously comprise also, or instead of Cu oxides, oxides of cerium and/or potassium. The total loading of the deposited metal oxides is preferably from about 1% to about 20% of the initial substrate weight. More preferably, the catalyst comprises 1-10% of iron oxides and 1-10% of oxides of a group consisting of copper, cerium and potassium. According to an advantageous embodiment of the present invention, the total loading of the deposited metal oxides is from about 1% to about 10%. According to another advantageous embodiment of the present invention, the catalyst comprises 1-5% of iron oxides and 1-5% of oxides of a group consisting of copper, cerium and potassium.

In a set of tests performed, it was observed that the useful operation temperature range of a catalyst in accordance with the present invention is generally lowered when increasing the metal loading. For example, a catalysts loaded with 4% iron oxides and 3% copper oxides shows high conversion of NO at a temperature range from about 250° C. to about 280° C., and high conversion of CO from about 150° C. to about 390° C. The lowering of the operation temperature depends on the ratio of the different metal loadings, and thus, the total weight of the oxides of Cu, Ce and K is preferably at least 25%, even more preferably at least 100%, of that of the Fe oxides.

Performed tests showed that catalysts comprising selected portions of oxides of iron, copper, cerium and potassium provide in oxidizing environment an 80-90% NO reduction at relatively low temperatures. More particularly, it was shown that NO emissions were reduced from an initial level of 260 ppmv to only 25-50 ppmv at temperatures from 250 to 360° C. in a simulated flue gas containing 3% O₂. Simultaneously, the CO oxidation was over 80-90%, and the levels of produced N₂O were very low, showing that the NO was mostly converted to N₂.

The proposed catalysts can be used for converting NO to N₂ by using CO as reductant, and also for converting excess CO to CO₂. Thus, the catalysts can be used for controlling the emissions of both pollutants simultaneously, or they can be used separately for CO control only. The catalysts can be used to treat exhaust gas stream from combustion processes of all types of carbonaceous fuels, including coal, biofuels, oil and natural gas as well as various waste fuels.

A catalyst according to the present invention is advantageously exposed to the gas stream to be treated at the temperature range of from about 125° C. to about 400° C. According to a preferred embodiment of the present invention, the catalyst is arranged at a temperature range from about 250° C. to about 400° C. in the flue gas channel of a carbonaceous fuel combusting process, for example downstream of an economizer of a pulverized coal (PC) or circulating fluidized bed (CFB) boiler. In some cases it may be advantageous to arrange the catalyst to a lower temperature, for example downstream of an air preheater, i.e. typically at a temperature below 180° C. Most preferably a catalyst according to the present invention is arranged at the range from about 250° C. to about 360° C.

According to the present invention, the active catalyst materials are impregnated on a porous support material including, but not limited to, activated alumina (AA), activated carbon (AC), silica, titania (TiO₂), and various types of zeolite. The support may be any material having desired pore/surface structure, physical strength and thermal stability. These catalysts may be used in fixed bed, moving bed, fluidized bed or injection-capture modes of operation. The fixed bed configuration can use granules, pellets or monoliths in the form of honeycomb, plate or corrugated plate.

By an arrangement and a process utilizing a catalyst according to the present invention, a high combustion efficiency can be maintained and very low levels of NOₓ from the combustion system can be achieved by using a small catalyst section and without adding any external reductant, such as ammonia, typically used for SCR processes.

### BRIEF DESCRIPTION OF THE DRAWINGS

FIG. 1 is a diagram of the NO conversion efficiencies of different catalyst materials as a function of temperature.

FIG. 2 is a schematic diagram of a PC boiler comprising an embodiment of the arrangement for controlling NO and CO emissions according to the present invention.

FIG. 3 is a schematic diagram of a PC boiler comprising another embodiment of the arrangement for controlling NO and CO emissions according to the present invention.

### DETAILED DESCRIPTION OF THE INVENTION

In the following, there are described results of bench scale tests of several exemplary catalysts, which were made to study their NO, CO and O₂ conversion rates as a function of temperature. The tests were performed by letting a constant stream of simulated flue gas, containing initially 260 ppm NO, 520 ppm CO, 3.0% O₂, 14.0% CO₂ and 83% N₂, to flow through a heated catalyst particle bed. The conversion rates were obtained by measuring the changes of the gas composition taking place across the catalyst bed.

Catalysts used in the tests were prepared by using an impregnation method with either activated carbon (AC) or activated alumina (AA) particles, having a particle size of 1-2 mm, as substrate. Reagent grade chemicals of metal nitrates were dissolved in 60° C. distilled water, and then support material particles were added while the solution was constantly stirred. The solution was evaporated for a few hours to obtain catalysts that were dry to touch. Activation of the catalysts was carried out by decompositioning the impregnated multi-metal nitrate salts, which was completed when the catalysts were slowly heated to 270° C. in an oxidizing gas atmosphere and maintained at this temperature for up to three hours. This preparation procedure was used to generate small samples for laboratory scale study, but different procedures may be used for preparing catalysts for large scale commercial applications.

The total surface area, observed by a BET-measurement, of the AC-based catalysts before the tests were typically about 470 m²/g and that of the AA-based catalysts were typically about 120 m²/g. For AA-based catalysts the measured surface area was clearly higher after the tests than before the tests. Preferably, the total surface area of the catalyst material is at least about 100 m²/g. The total surface areas of the tested catalysts were so high that the metal loadings used provided on the average less than a monolayer of metal oxides on the surface.

Background tests made for pure activated carbon (AC) samples showed that at temperatures above 300° C., the AC itself catalyzes NO conversion at a rate increasing with temperature. However, still at the temperature of 350° C., the NO conversion was only about 20%. When increasing temperature, the CO concentration of the output stream increases proportionally to the NO conversion. At the same time, there is O₂ consumption which is as well proportional to the NO conversion, but higher than that required for the observed CO generation. This result shows that at these conditions there is combustion and partial combustion of carbon of the substrate, generating CO₂ and additional CO. While there is clear correlation with the NO conversion and the CO generation, the generation of CO seems to be needed for NO conversion on pure AC. No CO reduction was observed at any temperature by these reference AC samples.

Tests with a catalyst having Fe oxide as the only added component on an AC support showed that Fe improves the catalyst reactivity. By a catalyst containing 4% Fe oxides, calculated of the initial substrate weight, (so-called 4% Fe loading) the NO reduction reached over 70% as the temperature was increased to about 330° C. The 4% Fe loading shifted the catalyst bed temperature required for 50% NO reduction (hereafter referred to as T₅₀) from about 380° C. of a pure AC sample (extrapolated from tested data range) to about 320° C. No CO reduction was noted by the catalyst, but, instead, there was clearly higher CO generation and O₂ consumption than with a pure AC sample. Thus, pure Fe loading increases NO conversion but also combustion and partial combustion of the carbon substrate.

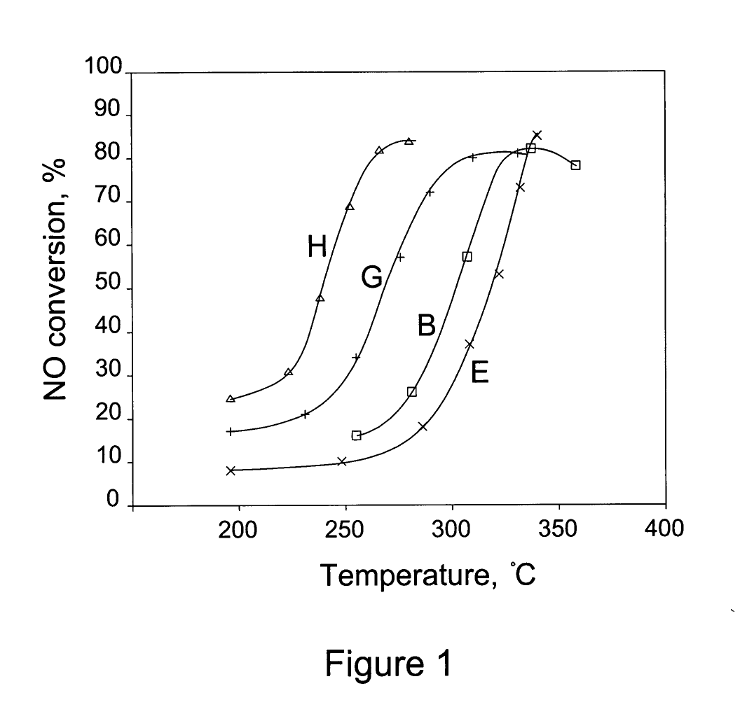

When adding both Fe and Cu oxides on an AC support, the catalyst reactivity was again clearly improved. FIG. 1 shows measured NO conversion rates for various AC-based catalysts as a function of temperature. The curve labeled E shows NO-conversion of a catalyst with pure 4% Fe loading, curve B of a catalyst with 1% Fe and 1% Cu loading, curve G of a catalyst with 4% Fe and 1% Cu loading and curve H of a catalyst with 4% Fe and 3% Cu loading. The curves show that all these catalysts provide at temperatures below 200° C. a relatively low NO conversion, typically 10-20%. The NO conversion starts to increase above a “light off” temperature, which is about 280° C. for curve E, i.e., for pure 4% Fe loading and, for example, about 200° C. for curve H, i.e., for 4% Fe and 3% Cu loading. All the curves reach a maximum NO conversion level of more than 80% at a temperature about 60-80° C. higher than the light off temperature.

With an AC-based catalyst loaded, in addition to 4% Fe and 3% Cu, also with 2% Ce, the NO conversion curve was still shifted to a still lower temperature by about 20° C. Similar effect was also observed by additional potassium oxide loading. Thus, in some applications it may be advantageous to use a catalyst which comprises oxides of Ce and/or K in addition to oxides of Fe, or Fe and Cu. Tentative tests show that Ce and K have an additional effect of improving the endurance of the catalysts in sulfur oxide containing environment.

The performed tests show that the range of useful operation temperature of the catalysts depends on the total metal loading. By increasing the metal loading, the useful temperature range is shifted to lower temperatures. According to these tests, in order to lower the operation temperature, the ratio of the weight of the metal oxides of the group consisting of copper, cerium and potassium to the weight of Fe oxides is preferably from about 0.25 to about 3, even more preferably from about 1 to about 3. In the performed tests, the lowest T₅₀, obtained by a catalyst with about 10% metal oxide loading, was about 200° C. It can, however be estimated that, with metal loadings up to 20%, the metal oxide layer still being less than a monolayer, the useful operation temperature can be extended to clearly below 200° C.

The O₂ conversion rates of the AC-based catalysts increase rapidly to a high level (typically 80-90%) at about the temperature where the NO conversion rate reaches its maximum. This indicates that in order to avoid burnout of the AC substrate, the AC-based catalysts should preferably be used slightly below their temperature of maximum NO conversion.

A notable CO depletion was observed for all catalysts loaded with oxides of iron and one or more of the group consisting copper, cerium and potassium. An AC-based catalyst with 4% Fe loading and 1% Cu loading provided high CO depletion from about 200° C. to about 330° C. At about 330° C., i.e., at the temperature where the maximum NO conversion was reached, the high CO depletion changed rapidly to clear CO generation. An AC-based catalyst with 4% Fe loading and 3% Cu loading provided high CO depletion, about 87 to 90%, to at least up about 390° C. With high metal loadings a high CO depletion could be extended down to as low temperatures as 125° C.

An activated alumina (AA) based catalyst with 4% Fe and 3% Cu loading reached a 50% NO conversion at about the same temperature, about 240° C., than corresponding AC-based catalyst, but reached a maximum NO conversion level of above 80% at about 20° C. higher temperature than the corresponding AC-based catalyst. AA-based catalysts showed a high CO conversion and negligible O₂ consumption over a wide temperature range. Thus, it seems clear that, notwithstanding the effects related to the burning of AC substrate material at high temperatures, the catalytic behaviour observed with AC-based catalysts is similar for catalysts having same metal loadings on corresponding other porous substrates.

Both AA- and AC-based catalysts displayed very good NO to N₂ selectivity. For all the tests with AC-based catalysts, 0-12% of the inlet NO was converted to N₂O, depending on the formulation of the catalyst and other test conditions. No significant amount of N₂O was formed by any of the AA-based catalysts tests. Test data also shows that the catalysts reduce NO also in reducing gas environment with CO as reductant.

These results indicate that a catalyst providing high NO and CO conversion levels at different temperature ranges, extending from about 125 to about 400° C., can be obtained by appropriate loadings of oxides of Fe and a group consisting of oxides of Cu, Ce and K. Catalysts with higher metal oxide loadings provide lower operation temperatures. Preferably, the ratio of the weight of the loading of oxides of Cu, Ce and K to that of Fe oxides is from about 0.25 to about 3, even more preferably from about 1 to about 3.

According to a preferred embodiment of the present invention, the active catalyst materials, oxides of Fe and one or more of Cu, Ce and K, are impregnated on powdery or granular porous carbon support. The porous carbon support is preferably activated carbon (AC) or similar low cost material such as gasifier char, the porosity of which may be quite alike that of normal commercial activated carbon. Because activated carbon may lose some weight due to oxidation while being contacted with hot flue gas, AC-based catalysts are preferably used by an operating mode including injection of the catalyst to the flue gas and capturing it with a dust collector, such as a fabric filter. The catalyst collected as a cake on the filter surfaces can advantageously function as a fixed bed, where further NO reduction may take place. The collected catalyst is preferably supplemented with fresh material and recycled to the flue gas.

Activated carbon is known to function also as a mercury adsorbent. Therefore, the present AC-based catalysts can simultaneously be used as sorbents for mercury capture. According to the performed tests, the NO and CO conversion levels of an AC-based catalyst loaded with 4% Fe and 3% Cu declines gradually in the presence of 200 ppm SO₂ in the gas stream, reaching in eight hours conversion levels of about half of their original levels. However, at the same time the catalyst material seemed to completely absorb the SO₂ in the gas. The same support material loaded by Fe only gave in the same conditions rise to only partial and continuously decreasing absorption of SO₂.

Thus, we have surprisingly observed that the present catalysts, especially when used in an injection—capture mode, can advantageously also be used as a polishing SO₂ sorbent. It is known that sulfur deposited on activated carbon increases its Hg sorption capacity. Thus, the present catalysts can be used as efficient catalysts for converting NO and CO to N₂ and CO₂ and/or as efficient sorbents of Hg and SO₂. Low-cost AC-based catalysts/sorbents can be directly disposed after being captured from the flue gas, or they can be regenerated and recycled.

A preferred way of using AC-based catalysts as multipollutant catalyst/sorbents in a boiler comprising a main flue gas desulfurization stage in the furnace, such as SO₂ sorbent addition in a CFB furnace, or in the upstream portion of the flue gas channel, is to inject fresh material in the downstream portion of the flue gas channel, preferably at a temperature from 250 to 340° C., and to collect particulate material in the flue gas. A first portion of the collected material may be disposed, but at least a second portion of the collected material may be injected to the furnace. In this method, the activated carbon is burned in the furnace, and the adsorbed SO₂ is recaptured by the main desulfurization stage. Mercury can be recovered either by another Hg capturing process from the flue gas, or from the sorbent material before the injection to the furnace and/or from the disposed material.

With an AC-based catalyst loaded with 4% Fe, 3% Cu and 2% Ce, the addition of 200 ppm SO₂ in the gas stream gave rise to a similar declining NO conversion level as for a similar catalyst without Ce. Also, complete absorption of the SO₂ was observed. However, contrary to the behavior of the corresponding Ce-free catalyst, the CO conversion level was not declining, but it was increased to a steady level of about 98%. With an AC-based catalyst loaded with 4% Fe, 3% Cu and 2% K, the addition of 200 ppm SO₂ gave rise to a declining NO conversion, slowly declining CO conversion, and nearly complete SO₂ absorption. Thus, in some applications, it may be advantageous to use a catalyst which comprises, in addition to Fe and Cu oxides, also a small amount of Ce oxide or potassium.

According to another preferred embodiment, the catalyst is formed into a honeycomb monolith for a fixed bed reactor. A monolithic honeycomb catalyst is advantageously made from uniformly blended fine powders of support material, binder and active metal materials. Such catalysts have an inherently homogenous distribution of the metal oxides for the entire volume of the substrate material. Thus they will have a higher activity on volume basis than the granular catalysts tested in laboratory.

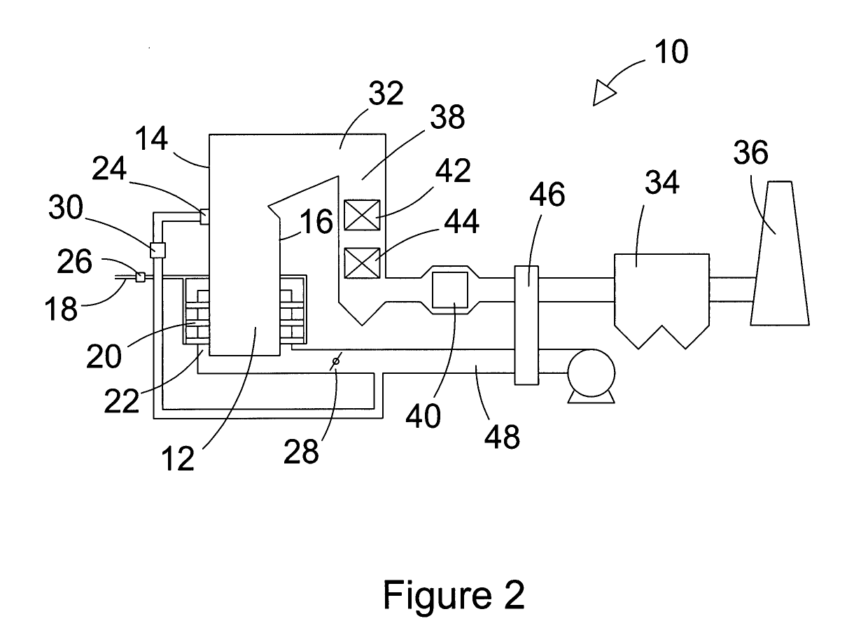

FIG. 2 shows a pulverized coal (PC) fired boiler 10 having an arrangement for controlling NOₓ emissions in accordance with the present invention. The boiler 10 comprises a furnace 12 enclosed with vertical tube walls, of which only walls 14 and 16 are shown in FIG. 2. The furnace is operated in oxidizing conditions, and therefore the walls 14, 16 can be made of normal carbon steel, and do not have to be completely covered with refractory material or to be made of corrosion resistant material.

The boiler 10 comprises conventional means 18, i.e., flow ducts and dividers, for introducing fuel and primary air through the burners 20 into the furnace 12. Adjacent to the burners 20 are disposed means 22, i.e., ducts and nozzles, for introducing secondary air into the furnace 12. At the upper portion of the furnace 12 are disposed nozzles 24 for injecting over-fire-air. The ducts for introducing fuel, secondary air and over-fire-air preferably comprise means 26, 28, 30 for controlling the streams of fuel, secondary air and over-fire-air, respectively, introduced into the furnace.

Flue gases produced during the combustion of the fuel in the furnace 12 are conducted from the furnace 12 through a flue gas channel 32, a dust collector 34 and a stack 36 to the atmosphere. The flue gas channel 32 comprises a heat transfer section 38, and a catalyst section 40 (having a catalyst as discussed in more detail below) disposed downstream from the heat transfer section 38. The combustion of the fuel in the furnace 12 is preferably performed with relatively low, say 10-20%, excess air. In these operating conditions, the amount of NOₓ at the furnace exit is low, usually below 90 ppm. Simultaneously, the concentration of CO in the flue gas increases to a higher level than normal. Due to the low NOₓ level, the catalyst in the catalyst section 40 is of a relatively small size.

According to the present invention, CO acts on the catalyst in the catalyst section 40 as a reductant, which reduces NO in the flue gas to N₂. At the same time, CO oxidizes to CO₂. The size and geometry of the catalyst in the catalyst section 40 are selected so that most, or preferably all, of the NO in the flue gas will be reduced on the catalyst. Any excess CO in the flue gas will preferably be oxidized to CO₂ on the surface of the catalyst by the excess oxygen in the flue gas.

In accordance with the present invention, the catalyst comprises iron oxides and oxides of at least one of the group consisting of copper, cerium and potassium, deposited on a porous support material. The catalyst is preferably formed as a fixed bed, such as a honeycomb monolith, made from uniformly blended fine powders of inert porous support material, such as activated alumina, binder and active metal materials.

Preferably, the boiler includes heat transfer surfaces, such as superheaters 42 and economizers 44, in the flue gas channel upstream from the catalyst section 40. By the economizer 44 the temperature of the flue gas is usually lowered to a temperature between 250 and 400° C. In the flue gas channel 32 downstream of the catalyst section 40 is located an air preheater 46 for heating the air in the air channel 48, and simultaneously lowering the temperature of the flue gas to a temperature between 125 and 180° C. The catalyst section 40, which is in FIG. 2 arranged upstream of the air preheater, may in some embodiments be alternatively placed downstream of the air preheater.

When the catalyst section is disposed upstream of the air preheater 46, at a temperature from about 250° C. to about 400° C., the weight of the total metal loading is preferably from about 1% to about 10%, of the weight of the substrate. When the catalyst section is downstream the air preheater, at a temperature from about 125° C. to about 180° C., the total metal loading is preferably from about 10% to about 20%, of the weight of the substrate.

As is clear from FIG. 2, the boiler, including means for utilizing a NO and CO control process according to the present invention, is very simple. The only major difference from a conventional boiler having an SCR unit is that the present boiler does not include means for handling and injecting an external NOₓ reducing agent. According to the present invention, the CO concentration in the flue gas is adjusted so that the CO reduces most or all of the NOₓ in the flue gas at the catalyst section 40.

The CO concentration in the flue gas is preferably adjusted by using an appropriate excess air level in the furnace 12. The boiler design may also include small modifications, e.g., certain local temperatures in the furnace 12, or modifications in the combustion zone or burner design, to control the CO/NOₓ ratio at the furnace outlet. Generally, however, the boiler itself does not differ substantially from a conventional boiler.

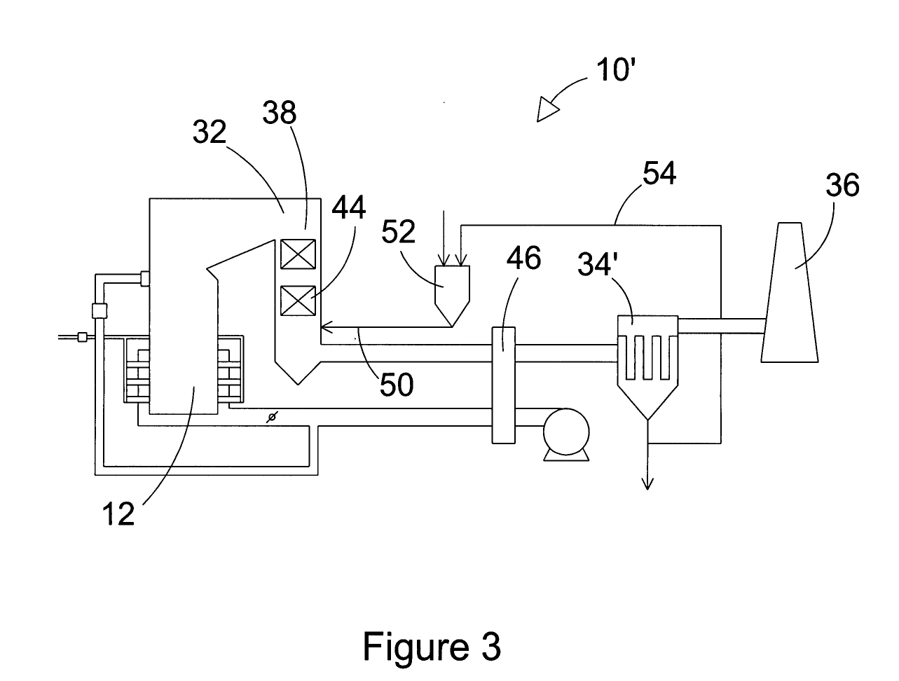

FIG. 3 shows another PC boiler 10′ including another embodiment of an arrangement for controlling NO and CO emissions from the boiler in accordance with the present invention. The boiler of FIG. 3 differs from that of FIG. 2 in that particulate catalyst material is injected to the flue gas channel 32 downstream of the economizer 44 through an injection nozzle 50. The catalyst particles are entrained with the flue gas stream along the flue gas channel, and they are collected by the dust collector 34′. Preferably, the dust collector 34′ is a filter unit, comprising, e.g., fabric filters, metal filters or ceramic filters, on the surfaces of which fly ash and catalyst particles form a packed bed through which the flue gas flows. When the filter unit is arranged at a suitable temperature, the reduction of NOₓ in the flue gas may continue still in the packed catalyst bed on the filter surfaces. Therefore, the catalyst material is advantageously deposited with relatively high loading of metals, or, alternatively, the filter unit 34′ is advantageously arranged upstream the air heater 46.

A portion of the particles collected in the dust collector 34′ is advantageously recycled through a recycling duct 54 back to a catalyst bin 52, and thereafter re-injected to the flue gas stream together with fresh catalyst particles. The rate of fresh catalyst feeding is preferably high enough to replenish the burn out of the catalyst particles or, even more preferably, high enough to maintain sufficient capacity of the catalyst/sorbent to capture SO₂ and Hg. The other portion of the particles collected in the dust collector 34′ is lead to further treatment or to a waste disposal site.

A significant advantage of the present arrangement is that CO replaces ammonia for catalytic reduction of NOₓ. Thus, the catalytic section is essentially an ammonia-free SCR. The capital costs, operating expenses and safety risks associated with the use of ammonia are avoided. The reductant is inherently generated during the boiler combustion process at no additional cost and without external handling. All the equipment associated with ammonia handling and injection, such as a storage tank, pumping and flow metering, vaporization, distribution and injection, is eliminated.

A critical requirement of conventional SCRs for efficient NOₓ reduction and ammonia slip control is uniform mixing of NH₃ with the flue gas. This requirement leads to expensive equipment, including an ammonia injection grid, flow mixers, multiple turning vanes and a flow rectifier grid. Such equipment is not needed in the present arrangement, since the reductant (CO) reaching the catalyst section 40 is already uniformily distributed in the flue gas channel 32, especially when passing through the heat exchange banks, i.e., superheaters 42 and economizers 44, in the flue gas channel 32.

Furthermore, the present arrangement also eliminates downstream problems associated with conventional SCRs, such as ammonia slip and the formation of ammonia bisulfate, which can cause fouling and corrosion of the air preheater surfaces 46, especially when high sulfur fuels are fired.

The operation of the boiler of our invention differs from that of a conventional boiler in that it allows the full potential of NOₓ control by the excess air adjustment to be utilized. Thus, the present method breaks the conventional relationship between furnace NOₓ and CO behavior. In fact, this concept inverts the CO/NOₓ relationship from being opposing to being supportive by utilizing the CO as a reductant.

The present concept provides an economic arrangement for achieving low furnace outlet NOₓ and high back-end catalytic NOₓ reduction without causing increased CO or NH₃ emissions or decreased boiler efficiency. The present invention is applicable to PC boilers, CFB boilers and other combustors used for burning solid carbonaceous fuels. The invention may as well be applied to boilers that combust liquid or gaseous carbonaceous fuels. It is to be noted that while the presently described catalysts provide high CO conversion in oxidizing conditions, they can also be used solely as CO catalysts arranged in the flue gas streams of various combustion processes.

While the invention has been described herein by way of examples in connection with what are at present considered to be the most preferred embodiments, it is to be understood that the invention is not limited to the disclosed embodiments, but is intended to cover various combinations or modifications of its features and several other applications included within the scope of the invention as defined in the appended claims.

We claim:

1. A method of controlling Hg and/or SO₂ emissions from a combustion system that combusts carbonaceous fuels, the method comprising the steps of:
(a) introducing carbonaceous fuel and combustion air into a furnace of the combustion system for combusting the carbonaceous fuel in oxidizing conditions and producing flue gas that includes Hg and/or SO₂; and
(b) leading flue gas from the furnace to contact with a sorbent in a flue gas channel, wherein the sorbent has a metal oxide loading comprising oxides of iron and and one or more of a group consisting of copper, cerium and potassium, deposited on a porous support material.

2. A method according to claim 1, wherein the support material is particulate porous carbon, such as activated carbon or gasifier char and the sorbent is injected into the flue gas channel and collected by a dust collector.

3. A method according to claim 2, wherein the sorbent is injected into the flue gas channel at a location, where the flue gas temperature is from about 125° C. to about 400° C.

4. A method according to claim 3, wherein the sorbent is injected into the flue gas channel at a location, where the flue gas temperature is from about 250° C. to about 340° C.

5. A method according to claim 4, wherein the combustion system comprises also a main flue gas desulfurization stage in the furnace or in an upstream portion of the flue gas channel, and a portion of the collected sorbent is injected to the furnace.

6. A method according to claim 1 or 2, wherein the weight of the metal oxide loading is from about 1% to about 20% of the weight of the support material.

7. A method according to claim 6, wherein the metal oxide loading comprises from about 1% to about 10% iron oxide and from about 1% to about 10% copper oxide, of the original weight of the support material.

8. A method according to claim 6, wherein the ratio of the weight of the oxides of said group to the weight of Fe oxides in the metal oxide loading is from about 0.25 to about 3.

9. A method according to claim 8, wherein the ratio of the weight of the oxides of said group to the weight of Fe oxides in the metal oxide loading is from about 1 to about 3.

10. An arrangement for controlling Hg and/or SO₂ emissions from a combustion system that combusts carbonaceous fuels, the arrangement comprising:
a furnace including means for introducing carbonaceous fuel and combustion air into the furnace for combusting the carbonaceous fuel in oxidizing conditions and producing flue gas including Hg and/or SO₂;
a flue gas channel for leading the flue gas from the furnace to the atmosphere; and
a sorbent section in the flue gas channel including a sorbent having a metal oxide loading comprising oxides of iron and and one or more of a group consisting of copper, cerium and potassium, deposited on a porous support material.

11. An arrangement according to claim 10, wherein the support material is particulate porous carbon, such as activated carbon or gasifier char and the arrangement comprises means for injecting sorbent particles into the flue gas channel and a means for collecting sorbent particles in the flue gas channel.

12. An arrangement according to claim 11, wherein the combustion system comprises also a main flue gas desulfurization stage in the furnace or in an upstream portion of the flue gas channel, and the arrangement comprises means for injecting a portion of the collected sorbent particles to the furnace.

13. An arrangement according to claim 11, wherein the means for injecting the sorbent is arranged into the flue gas channel at a location, where the flue gas temperature is from about 125° C. to about 400° C.

14. An arrangement according to claim 10 or 11, wherein the weight of the metal oxide loading is from about 1% to about 20% of the weight of the support material.

15. An arrangement according to claim 14, wherein the metal oxide loading comprises from about 1% to about 10% iron oxides and from about 1% to about 10% oxides of said group, of the original weight of the support material.

16. An arrangement according to claim 14, wherein the ratio of the weight of the oxides of said group to the weight of Fe oxides in the metal oxide loading is from about 0.25 to about 3.

17. An arrangement according to claim 16, wherein the ratio of the weight of the oxides of said group to the weight of Fe oxides in the metal oxide loading is from about 1 to about 3.
